(19) United States
(12) Patent Application Publication
(10) Pub. No.: US 2013/0259255 A1
(43) Pub. Date: Oct. 3, 2013

(54) EXTENSIBLE SMART HEADPHONE SYSTEM

(71) Applicant: IMATION CORP., Oakdale, MN (US)

(72) Inventors: Eran Schul, St. Paul, MN (US); Douglas K. Hogue, Woodbury, MN (US); Alan Olson, Cottage Grove, MN (US); John Bruss, Culver City, CA (US)

(73) Assignee: Imation Corp., Oakdale, MN (US)

(21) Appl. No.: 13/795,143

(22) Filed: Mar. 12, 2013

Related U.S. Application Data
(60) Provisional application No. 61/618,158, filed on Mar. 30, 2012.

(51) Int. Cl. H04R 1/10

(52) U.S. Cl. CPC H04R 1/1041
USPC 381/74

(57) ABSTRACT

A headphone system executing application programs on a media device to perform enhanced functions without burdening the headphones, including a headphone connector which receives signals from the media device, identifies command signals, and makes responses thereto. The system identifies the features of the headphones and what functions can be applied thereto, and performs those functions. The system includes one headphone cup for each ear, each including an embedded speaker and microphone. The microphones provide signals regarding sound present at the listener's ears, which are combined and input to the media device. The programs analyze signals from the microphones and apply signal processing techniques to outgoing signals.

### RELATED U.S. APPLICATION DATA

This application claims priority to U.S. provisional Application No. 61/618,158, filed Mar. 30, 2012, and incorporated herein by reference.

The subject matter of this application is also related to that of the following applications, each of which is incorporated by reference in its entirety for all purposes: U.S. non-provisional application Ser. No. 13/772,650, entitled “HEADPHONE RESPONSE OPTIMIZATION” (attorney docket. P231748.US.02), filed Feb. 21, 2013, which claims priority to U.S. provisional Application No. 61/601,467, filed Feb. 21, 2012; and U.S. non-provisional application Ser. No. ______, entitled “SOUND PRESSURE LEVEL LIMITING” (attorney docket. P231747.US.02), filed on even date herewith, which claims priority to U.S. provisional Application No. 61/618,187, filed Mar. 30, 2012. These documents are sometimes referred to herein as the incorporated disclosure.

### BACKGROUND OF THE DISCLOSURE

Currently, smartphones and other personal media devices are capable of storing or downloading music and other media files. These devices can process those media files and generate electronic audio signals. These devices can be coupled with a headphone either through a standard headphone jack, a proprietary multi-pin connector, or a wireless connection such as using the Bluetooth™ technology standard, enabling a user to listen to the audio signals. The standard headphone connection found on these devices incorporates a stereo (2-channel) output and a mono (1-channel) input.

Currently, headphones can be coupled to these smartphones or other personal media devices, and can be disposed to receive these electronic audio signals and provide sound for a listening user. As new functions are developed from time to time, it would be advantageous for these new functions to be added to the headphones, or for the headphones to be upgraded to include these new functions, without having to physically replace the headphones. Some of these new functions are described in the incorporated disclosures, referenced above, including the possibilities of (A) equalization or other real-time adjustment of the electronic audio signals to account for the shape and size of the listener's ears, or (B) adjusting the electronic audio signal so as to limit the sound pressure level presented to the listener's ears, so as to prevent hearing damage from excessive sound pressure. Other new functions, and other enhancements to the listener's experience can be provided as they are developed from time to time.

As described in the incorporated disclosures, referenced above, some of these new functions can be implemented using a feedback mechanism, such as including one or more microphones in headphone ear cups, so as to provide information regarding the sound waves being presented to the listener's ears. Similarly, as described in the incorporated disclosures, referenced above, some of these new functions can be implemented using signal processing circuitry, such as a digital signal processor suitably programmed to implement these new functions.

One method to add new functions to headphones would be to implement those new functions in software in the physical headphones, and to upgrade or replace the software with new software, programmed with new signal processing methods to implement these new functions, as these new functions become available. While this technique generally achieves the purpose of providing new functions as they become available, it is subject to a number of drawbacks. These drawbacks include (A) headphones designed to be programmable involve relatively expensive signal processing circuitry, or alternatively, relatively expensive processors and limited memory which can maintain only relatively few embedded signal processing algorithms; (B) headphones designed to be programmable involve relatively expensive and bulky power sources; and (C) headphones designed to be programmable involve an additional communication path for upgrading or replacing the software used to provide signal processing methods in those headphones.

### SUMMARY OF THE DISCLOSURE

We provide an audio headphone system, that uses the processing power of a coupled smartphone or other personal media device to execute one or more application programs. These application programs can perform signal processing and other enhanced headphone functions, without burdening the headphones with significant additional circuitry, power requirements, communication requirements, or weight.

In one embodiment, additional headphone features can be performed by one or more application programs, such as executing on a personal media device, operating under control of an operating system for that personal media device. For example, one or more application programs might operate under control of the Android™ operating system or the iOS™ operating system available from Apple Corporation. As these operating systems for personal media devices are generally designed to allow new application programs to be created, downloaded, and executed on the personal media device, they have the effect of allowing an audio headphone system to use the processing power of the personal media device, including accessing and controlling input and output electronic audio signals exchanged with the headphone system.

In one embodiment, the headphone system includes a headphone connector disposed to receive electronic audio signals from the personal media device, disposed to identify command signals and other information in those electronic audio signals, and disposed to make responses to those command signals to the personal media device. The personal media device can readily identify the hardware features of the headphone system, can readily identify what signal processing functions can be applied to electronic audio signals to enhance the listener's experience, and can readily perform those signal processing functions without substantial reliance on the capabilities of the headphone system. If the personal media device does not have appropriate or necessary application programs installed, or if the headphone system cannot identify and respond to commands signals or other information from the application programs, the headphone system degrades gracefully to a system capable of operating as an audio playback device, but without enhanced headphone features.

In one embodiment, the headphone system includes one headphone cup for each one of the listener's ears, each including one or more speakers and one or more microphones embedded in the headphone cup, that is, one such set of speakers and microphones for each of the listener's ears. The headphone speakers are coupled to the audio output signals from the personal media device using a standard headphone connector such as a 3.5 mm TRRS (tip, ring, ring, sleeve), or using a wireless connection technology such as the Bluetooth™ technology standard. The microphones perform as acoustic sensors, able to sense sound waves present at each of the listener's ears. The microphone signals can be combined and coupled to the microphone input of the same 3.5 mm TRRS headphone connector. Alternatively, the individual microphone signals along with the individual headphone speaker signals can be coupled to the personal media device using the device's multi-pin interface connector, if one exists.

In one embodiment, the system includes one or more software elements, such as application programs, which are executed by the personal media device under control of an operating system. The one or more software elements can analyze the input signals from the microphones, and apply one or more signal processing techniques to electronic audio signals destined for the speakers, such as to alter the audio output signal in response to signals received from the microphones and in response to a desired function to be performed. As described herein, these one or more application programs can be downloaded, or can be upgraded using one or more downloaded additional or replacement software elements, to provide new or improved functions, without modification of the hardware features of the headphone system.

### BRIEF DESCRIPTION OF THE DRAWINGS

FIG. 1 shows a conceptual drawing of an extensible smart headphone system.

In the figures, similar components or features might have the same reference label. Similar components or features, or those of the same type, might be distinguished by following the reference label by a dash and a second label that distinguishes them. Where only the first reference label is used, the description is applicable to any similar component having the same first reference label.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiments of the disclosure. It should be understood that various changes may be made in the function and arrangement of elements without departing from the spirit and scope of the invention as set forth in the appended claims.

Terms and Phrases

The text “application” or “application program” generally refers to any program, set of instructions, or other one or more control elements, capable of being executed or interpreted by a personal media device. In one embodiment, application programs are executed by the personal media device under control of an operating system program, such as the Android™ operating system or the iOS™ operating system.

The text “personal media device” generally refers to any device capable of accessing media signals and generating audio signals for presentation to a listener. Example personal media devices include MP3 players, smartphones, and other devices. Smartphones include, for example, the iPhone™ by Apple Corporation, as well as phones using the Android™ operating system. Other devices include, for example, the iPod™ and iPad™ by Apple Corporation, the Kindle Fire™ by Amazon Corporation, as well as other touchpads or tablet computers, netbooks, laptops, and personal computers, as well as equivalent consumer electronic devices.

Figures and Text

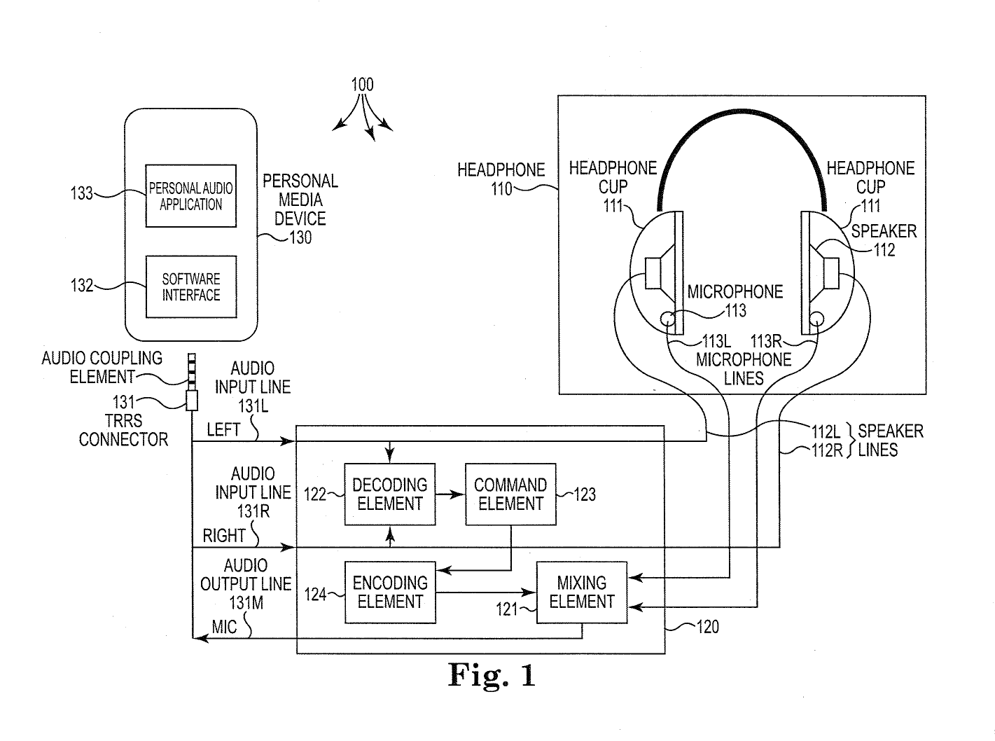

FIG. 1 shows a conceptual drawing of an extensible smart headphone system.

A system 100 includes elements as shown in the figure, including at least one or more headphones 110, a headphone interface 120, and a personal media device 130. The system 100 can contain other and further components or elements as may be described herein, not necessarily shown in the figure.

As described herein, the system 100 operates to provide a headphone system, in which a personal media device, operating under control of an application program, which can provide functions which are additional to, or extensions of, or replacements of, those which were part of an original headphone design. As described herein, particular elements of the system 100 operate to perform these functions.

Headphones

In one embodiment, the headphones 110 (referring collectively to a headphone assembly including left and right headphone elements) include elements as shown in the figure, each including at least one or more headphone cups 111 (such as right and left headphone cups 111) disposed for positioning about the listener's ears (not shown), each including both one or more speakers 112 (such as right and left speakers 112 disposed in the headphone cups 111) and one or more microphones 113 (such as right and left microphones 113 disposed in the headphone cups 111). The headphones 110 can contain other and further components or elements as may be described herein, not necessarily shown in the figure.

In one embodiment, the speakers 112 are disposed to receive electronic audio signals directed from associated speaker lines 112L and 112R, and to present sound waves to the listener's ears. As described herein, each listener's ear has one or more speakers 112 associated therewith. Similarly, in one embodiment, the microphones 113 are disposed to receive sound waves found in the headphone cups 111 and to send electronic audio signals representing those sound waves to associated microphone lines 113L and 113R coupled to the headphone interface 120. As described herein, each listener's ear has one or more microphones 113 associated therewith.

This application primarily describes a system 100 in which the microphones 113 are disposed to receive sound waves found within the headphone cups 111, such as might be used in the context of audio equalization or sound pressure limitation, as the latter are further described in the incorporated disclosure. However, in the context of the invention, there is no particular requirement for any, such limitation. For example, the microphones 113 can be disposed to receive other sound waves for which electronic signals are desired to be sent to the personal media device 130. In one such example, the microphones 113 can be disposed to receive sound waves found outside the headphone cups 111, such as might also be used in the context of sound pressure limitation, and the personal media device 130 can be disposed to account for the additional sound pressure from those sound waves found outside the headphone cups 111 when determining a maximum volume for the speakers 112.

This application also primarily describes a system 100 in which there are two microphones 113, each disposed in one of the headphone cups 111, and in which those two microphones 113 generate separate electronic audio signals, each representing sound waves at one of the headphone cups 111, thus providing separate electronic audio signals to the associated microphone lines 113L and 113R. However, in the context of the invention, there is no particular requirement for any such limitation. For example, the microphones 113 can be disposed to receive other sound waves desired to be sent to the personal media device 130, and to mix those other sound waves onto one or more associated microphone lines, such as onto the associated microphone lines 113L and 113R.

In one embodiment, the headphones 110 can include a voice microphone (not shown) disposed outside the headphone cups 111 and near a wearer's mouth, with the effect that a wearer of the headphones 110 can speak into the voice microphone and provide an electronic voice signal for input to the personal media device 130. For example, the electronic voice signal can be used for voice telephony, that is, spoken voice signals when placing or making telephone calls, or for voice memos, that is, spoken voice signals when recording or annotating voice recordings, or for other purposes, including telephone calls, text or email messages, or other communications.

In one embodiment, the voice microphone is integrated into a headphone cable, such as using a voice microphone line (not shown). In one embodiment, the voice microphone can be disposed to activate a push-to-talk control signal to indicate that the voice microphone is enabled. The headphone interface 120 would monitor the headphone cable for the push-to-talk signal. For example, the push-to-talk control signal can be coupled to the mixing element 121 and to the personal audio application 133. When the push-to-talk control signal is activated, the mixing element 121 would disable both the microphones 113 and the microphone lines 113L and 113R, and would also disable the encoding element 124. When the push-to-talk control signal is activated, the personal audio application 133 would also disable electronic audio signals to the speakers 112 on speaker lines 112L and 112R. This has the effect that use of the voice microphone would override other operation of the headphone interface 120 and the personal audio application 133. The mixing element 121 and the personal audio application 133 would resume normal operation when use of the voice microphone is completed.

Headphone Interface

In one embodiment, the headphone interface 120 includes circuits or other components, coupled to the headphones 110 and coupled to the personal media device 130. The headphone interface 120 is disposed to receive signals from the personal media device 130 and to respond to the personal media device 130, as described herein. The headphone interface 120 is also disposed to receive signals from the personal media device 130 and to forward those signals to the headphones 110.

In one embodiment, the headphone interface 120 includes elements as shown in the figure, including at least a microphone mixing element 121, a decoding element 122, a command element 123, and an encoding element 124. The headphone interface 120 can contain other and further components or elements as may be described herein, not necessarily shown in the figure.

The headphone interface 120 is disposed to transmit information from the headphones 110 to the headphone interface 120 to the personal media device 130. The headphone interface 120 is coupled to the speaker lines 112L and 112R and to the microphone lines 113L and 113R, all of which are coupled to the headphones 110 as described above. In embodiments in which wireless connections are used, the speaker lines 112L and 112R, or the microphone lines 113L and 113R, or both, might be emulated by one or more wireless data connections.

The headphone interface 120 is also disposed to transmit information from the personal media device 130 to the headphone interface 120 to the headphones 110. The headphone interface 120 is coupled to one or more left audio input lines 131L, for electronic audio signals directed to the left speaker line 113L. Similarly, the headphone interface 120 is coupled to one or more right audio input lines 131R, for electronic audio signals directed to the right speaker line 113R. Similarly, the headphone interface 120 is also coupled to one or more audio output lines 131M, for electronic audio signals received from both the microphone lines 113L and 113R, and electronic audio signals received otherwise, as described herein. In embodiments in which wireless connections are used, the audio input lines 131L and 131R, or the audio output line 131M, or both, might be emulated by one or more wireless data connections.

In one embodiment, the left audio input line 131L and the right audio input line 131R are both coupled to inputs of the decoding element 122, and are further both coupled to their respective left speaker line 112L and right speaker line 112R. This has the effect that the left audio input line 131L and the right audio input line 131R are coupled, without substantial change to their electronic audio signals, to their respective speakers 112. The left audio input line 131L and be right audio input line 131R thus present electronic audio signals to the speakers 112 to present sound waves to the listener's ears.

Decoding Element. The decoding element 122 receives inputs from the left audio input line 131L and the right audio input line 131R, and provides a signal to the command element 123. This has the effect that the personal media device 130 can generate command signals which can be received and acted upon by the headphone interface 120.

While this application primarily describes a system 100 in which the decoding element 122 sends command signals to the command element 123, in the context of the invention, there is no particular requirement for any such limitation. For example, the decoding element 122 can send other types of information besides command signals, such as request signals, status signals, and other types of information signals or control signals.

In one embodiment, the input signals from the personal media device 130 to the decoding element 122 can include any appropriate or convenient form of encoding of the command signals or other information. Some examples include the following:

The command signals or other information can include DTMF (dual-tone multi-frequency) signals, such as known in the field of telephony. In one embodiment, the command signals or other information are encoded using ultrasonic DTMF signals including frequencies just beyond the range of human hearing. Other and further possible encodings are described below.

The command signals or other information can include modem signals, such as known in the field of digital signal transmission. In one embodiment, the command signals or other information are encoded using modem signals having frequencies beyond the range of human hearing.

The command signals or other information can include buzzing or clicking sounds, such as known in the field of Morse code. In one embodiment, the command signals or other information are encoded using Morse code having frequencies beyond the range of human hearing.

The command signals or other information can include other types of encoding, or some combination or conjunction of more than one type of encoding.

The command signals or other information can be disposed at frequencies above human hearing range, within human hearing range, or a mixture of both. In one embodiment, the command signals or other information are disposed at frequencies just beyond the range of human hearing, with the effect that, when forwarded to the speakers 112, the listener does not hear them. In this context, “beyond the range of human hearing” includes both those frequencies which are too low for most persons to hear and those frequencies too high for most persons to hear.

However, in the context of the invention, there is no particular requirement for any such limitation. For example, the command signals or other information can be deliberately disposed at frequencies within human hearing range, with the intent of providing an identifiable sequence of sounds to the listener. In one such example, that identifiable sequence of sounds can provide an aural identification to the listener that the headphones 110 are being operated as part of the system 100. Optionally, that identifiable sequence of sounds can provide an aural identification to the listener that operation of the headphones 110 is being initiated. In another such example, the identifiable sequence of sounds can provide an aural trademark for the particular brand of headphones 110 or the particular brand of the system 100.

Moreover, command signals or other information can include sound waves which are deliberately induced into the headphone cups 111. For a first example, in performing audio equalization, it might be desirable to determine a frequency response from the listener's ear geometry to one or more particular frequencies. Similarly, for a second example, in performing sound pressure limiting, it might be desirable to determine a measure of attenuation when a particular frequency is presented to the listener's ear. In such examples, the command signals or other information can include electronic audio signals disposed to provide sound waves in one or the other, or both, headphone cups 111 which include those particular frequencies and for which the response can be measured by one or the other, or both, microphones 113.

In alternative embodiments, it may occur that the command signals or other information include frequencies that are within human hearing range, but are expected to be unpleasant to most listeners. In such cases, the system 100 may mask those frequencies that are within human hearing range by overlaying them with other, lower, frequencies which are also within human hearing range, and which in combination, provide a more pleasant experience for the listener.

Command Element. The command element 123 receives the encoding command signals or other information from the decoding element 122, generates a response thereto, and provides that response to the encoding element 124. In one embodiment, the command element 123 can include any technique by which the encoded command signals or other information are interpreted, executed, or otherwise responded to.

For one example, the command element 123 can include a processor disposed for interpreting the command signals, executing instructions in response to those command signals, and providing a signal responsive thereto. For another example, the command element 123 can include a finite state machine (such as implemented using one or more hardware circuits, or one or more circuits operating under control of particular software) disposed for receiving the command signals, altering its state in response to those command signals, and providing a signal responsive thereto. After reading this application, those skilled in the art would recognize other and further possible embodiments of the command element 123, without any requirement for undue experimentation or new invention.

In one embodiment, the command element 123 receives the command signals, and responds thereto, without maintaining any particular state information from one command signal to the next. However, in the context of the invention, there is no particular requirement for any such limitation.

For example, the command element 123 can maintain state information in response to one or more first command signals, and can respond to one or more later second command signals differently depending upon distinct state information it maintains. In one such example, one or more first command signals can direct the command element 123 to alter its state (possibly, conditionally upon the state of the headphones 110 or a portion thereof), and one or more later second command signals can direct the command element 123 to respond with information about its current state.

In alternative embodiments, in which the command element 123 operates under control of one or more instructions or software elements, one or more command signals may be disposed to direct the command element 123 to augment, upgrade, or replace those instructions or software elements. For example, the personal media device 130 may download new instructions or software elements, and may issue one or more command signals to install those new instructions or software elements in the command element 123.

Examples of command signals and other information to which the command element 123 responds can include the following:

The command signals can direct the command element 123 to identify the type of brand and model for the headphones 110. For example, the command signals can direct the command element 123 to identify the type of headphones 110, to identify the make and model of headphones 110 (such as whether the headphones 110 are Memorex™ headphones, and if so, which particular brand of Memorex™ headphones).

The command signals can direct the command element 123 to identify the type of speakers 112 or microphones 113 included in the headphones 110.

The command signals can direct the command element 123 to identify the type of software elements used as drivers for the headphones 110, such as the type of software elements used as drivers for the speakers 112 or for the microphones 113.

The command signals can direct the command element 123 to cause one or more of the microphones 113 to be activated or deactivated. In such examples, the command element 123 can either (A) direct the mixing element 121 to enable or disable one or more of the microphones 113, or (B) direct the headphones 110 to enable or disable one or more of the microphones 113. These alternatives are further described below.

The command signals can direct the command element 123 to make other and further responses, or some combination or conjunction of more than one type of response.

After reading this application, those skilled in the art would recognize other and further possible command signals and other information to which the command element 123 responds, without any requirement for undue experimentation or new invention.

Upon identifying the type of headphones 110, or the type of components therein, the system 100 can determine which functions can be applied by the personal media device 130, in view of the physical capabilities of the headphones 110. This has the effect that the system 100 can offer the listener one or more choices of which of those functions to apply. For example, if the system 100 determines that both audio equalization and sound pressure limiting can be applied by the personal media device 130, the system 100 can offer the listener a choice of which one or more of those functions to apply. The listener might choose to apply audio equalization, or to apply sound pressure limiting, or to apply both of those functions. Moreover, the system 100 can use the input/output features of the personal media device 130 to present appropriate choices to the listener, and to receive selections from the listener.

It might occur that the particular brand of headphones 110 does not include any headphone interface 120. In such cases, there would be no command element 123 to respond to the command signals or other information, with the effect that the personal media device 130 would not receive a response to those command signals or other information. Thus, lack of response (or optionally, a repeated lack of response) would indicate to the personal media device 130 that the particular brand of headphones 110 do not include any headphone interface 120. The personal media device 130 can then treat the headphones 110 as “dumb” headphones, that is, non-extendable headphones with only their capabilities as originally designed.

Similarly, it might occur that the particular brand of headphones 110 includes a headphone interface 120 with only limited capabilities. In such cases, the command element 123 in the headphone interface 120 might be unable to respond to one or more particular command signals or other information, with the effect that the personal media device 130 would not receive a response to those particular command signals or other information. Similarly, lack of response, or repeated lack of response, would indicate to the personal media device 130 that the particular headphone interface 120 has only limited capabilities. The personal media device 130 can then treat the headphones 110 as “dumb” headphones with respect to those capabilities.

Encoding Element. The encoding element 124 receives inputs from the command element 123, and provides a signal to the mixing element 121. This has the effect that the personal media device 130 can receive responses that are provided by the command element 123 in response to the command signals generated by the personal media device 130. More specifically, in response to the command signals and other information from the personal media device 130, responses from the command element 123 are encoded, and the encoded signals are mixed into the one or more audio signals delivered from the headphones 110. This has the effect that those responses are prepared for delivery to the personal media device 130.

While this application primarily describes a system 100 in which the command element 123 and the encoding element 124 provide responses for sending to the personal media device 130, in the context of the invention, there is no particular requirement for any such limitation. For example, the command element 123 and the encoding element 124 can provide other types of information besides responses to command signals from the personal media device 130.

In a first such example, the command element 123 and the encoding element 124 can provide status information (whether periodically, in response to some triggering event, or otherwise) to the personal media device 130, or to the headphones 110, or to some combination or conjunction thereof. In a second such example, the command element 123 and the encoding element 124 can provide instructions to be acted upon (whether at the discretion of the receiving device, or otherwise) to the personal media device 130, or to the headphones 110, or to some combination or conjunction thereof.

In one embodiment, the encoding element 124 uses the same encoding technique (or a similar encoding technique) as used by the personal media device 130 when encoding signals for sending to the decoding element 122. That is, in one embodiment, the encoding element 124 encodes signals using an ultrasonic DTMF technique, including frequencies just beyond range of human hearing.

However, in the context of the invention, there is no particular requirement for any such limitation. For example, the encoding element 124 can use one or more of the types of encoding described with respect to the signals from the personal media device 130, the decoding element 122, or some combination or conjunction thereof.

In alternative embodiments, the encoding element 124 can use other types of encoding, including without limitation, modem signals, Morse code, frequencies (in whole or in part) within the range of human hearing, other types of encoding, or combinations or conjunctions of more than one type of encoding. As the signals output from the encoding element 124 are not sent to the listener's ears, there is no particular requirement that the encoded signals avoid frequencies within the range of human hearing.

Mixing Element. The mixing element 121 is coupled to multiple inputs, including an output from the encoding element 124, and one or more outputs from each of the microphones 113 (that is, including electronic audio signals received from both the microphone lines 113L and 113R), as well as (optionally) other electronic signals, as otherwise described herein. The mixing element 121 is coupled to an output, which is coupled to an input to the personal media device 130, as described below. This has the effect that the mixing element 121 can provide a combined signal to the personal media device 130, in which the combined signal includes information from multiple sources, as described herein.

In one embodiment, the mixing element 121 can use any appropriate or convenient technique for mixing signals from multiple inputs onto a single output. In one embodiment, the mixing element 121 can simply sum its input signals to provide its output signal. In alternative embodiments, the mixing element 121 may use a different technique, such as frequency modulation onto distinct frequency bands, or otherwise.

In one embodiment, the command element 123 can determine which ones of the inputs to the mixing element 121 that the mixing element 121 will include in the combined signal. The mixing element 121 receives information from the command element 123 with respect to that determination, and in response thereto, includes only those inputs in the combined signal as directed by the command element 123. For example, the command element 123 can decide to include, or to not include, one or both of the electronic signals received from the microphone lines 113L and 113R.

Upon communication of that decision by the command element 123 to the mixing element 121, the command element 123 thus causes the mixing element 121 to only provide an output from the right microphone 113, or alternatively, an output from the left microphone 113, to the personal media device 130. This allows the command element 123 and the mixing element 121 effectively to turn off one of the microphones 113 (as perceived by the personal media device 130), which allows the personal media device 130 to process an input signal which is restricted to only the other microphone 113. This has value when the personal media device 130 attempts to make corrections to the electronic audio signal directed to only one of the listener's ears, that is, to only one of the speakers 112.

Personal Media Device

In one embodiment, the personal media device 130 includes a smartphone or other personal media device, capable of executing instructions or other software elements, coupleable to the headphone interface 120, and disposed to perform digital signal processing on data to generate electronic audio signals to be sent to the headphones 110.

In one embodiment, the personal media device 130 includes elements as shown in the figure, including at least an audio coupling element 131, a software interface element 132, a personal audio application 133, and a media player application (not shown). The personal media device 130 can contain other and further components or elements as may be described herein, not necessarily shown in the figure.

Audio Coupling Element. The audio coupling element 131 provides a connection between the headphone interface 120 and the personal media device 130. In one embodiment, the audio coupling element 131 includes a 3.5 mm TRRS (tip, ring, ring, shield) connection, including a TRRS jack integrated into the personal media device 130 and a TRRS plug integrated into the headphone interface 120. However, as noted in the incorporated disclosure, in the context of the invention, there is no particular requirement for any such limitation. For one example, the audio coupling element 131 can include a multi-pin connection including multiple electronic signals capable of being received from, or sent to, the personal media device 130. For another example, the audio coupling element 131 can include a wireless transceiver, so that the headphone interface 120 can communicate with the personal media device 130 using the Bluetooth™ technology standard. Other and further techniques for communication between the headphone interface 120 and the personal media device 130 are also possible, such as other wireless communication techniques, infrared communication techniques, combinations and conjunctions thereof, and otherwise.

In one embodiment, the audio coupling element 131 includes one or more connectors, including one or more left audio output lines 131L (for electronic audio signals directed to the left speaker line 113L, as noted above), one or more right audio output lines 131R (for electronic audio signals directed to the right speaker line 113R, as noted above), and one or more audio input lines 131M (for electronic audio signals received from the mixing element 121, as noted above).

In one embodiment, the audio coupling element 131 is coupled to the headphone interface 120 and to the software interface element 132, and is disposed both (A) for receiving electronic signals from the headphone interface 120 and sending them to the software interface element 132, and (B) for receiving electronic signals from the software interface element 132 and sending them to the headphone interface 120.

Software Interface Element. The software interface element 132 includes a software application capable of being executed by the personal media device 130, and capable of exchanging information with the headphone interface 120. In one embodiment, the software interface element 132 receives command signals and other information from the personal audio application 133, and provides those command signals and other information to the headphone interface 120 in a format capable of being understood by the latter. Similarly, in one embodiment, the software interface element 132 receives electronic signals from the headphone interface 120, and provides those signals to the personal media application 133 in a format capable of being understood by the latter.

Personal Audio Application. The personal audio application 133 includes a software application capable of being executed by the personal media device 130, and capable of generating command signals and other information to be sent to the headphone interface 120, and capable of gleaning information about the headphones 110 from the responses (or lack thereof) made by the headphone interface 120. As described above, in one embodiment, the command signals or other information 10 can include requests for information from the headphone interface 120, such as requests for identification of the type of headphones 110 or components thereof.

In one embodiment, the headphone interface 120 would respond to requests for information with appropriate information regarding headphones 110, or components thereof, such as with identification information including make and model number, purchase date, last warranty work, and/or other information. The personal audio application 133 can use that identification information to adjust any electronic audio signals destined for the headphones 110.

For example, the personal audio application 133 can use equalization techniques (such as those described in the incorporated disclosure, “Headphone Response Optimization”), sound pressure limiting techniques (such as those described in the incorporated disclosure, “Sound Pressure Level Limiting”), and other techniques which are included in the personal audio application 133. In such examples, the personal audio application 133 can even use functions provided by the owner of the personal media device 130, such as might be implemented by new instructions or software elements which may be downloaded or programmed by the owner of the personal media device 130.

In one embodiment, the personal audio application 133 can be updated or upgraded, modified or revised, corrected or fixed, or otherwise replaced, with new instructions or software elements, such as using application update techniques available with respect to the operating system being executed by the personal media device 130. This has the effect that the personal audio application 133 can have its functions similarly updated or upgraded, modified or revised, corrected or fixed, or otherwise replaced. Thus, the system 100, including the headphones 100, headphone interface 120, and a personal media device 130, collectively can be improved, notwithstanding that the physical headphones 100 are not modified or replaced.

Similarly, the software interface element 132 can be updated or upgraded, modified or revised, corrected or fixed, or otherwise replaced, with new instructions or software elements, such as using application update techniques available with respect to the operating system being executed by the personal media device 130. This has the effect that the software interface element 132 can have its functions similarly updated or upgraded, modified or revised, corrected or fixed, or otherwise replaced. For example, when the personal audio application 133 is updated or upgraded, the software interface element 132 can be updated or upgraded to account for new functions that the personal audio application 133 is capable of, or new information that is available to the personal audio application 133, or that the personal audio application 133 can make use of.

In one embodiment, the personal audio application 133 is coupled to one or more media player applications. The one or more media player applications are disposed to translate digital media information into analog electronic audio signals, ultimately to be sent to the headphones 110 and the listener's ears. For example, one such media player application can be a music application, or other media player application, such as the iTunes™ application available for iOS, or another such application available for the Android™ operating system.

While this application primarily describes systems in which the application program is executed by the personal media device 130, in the context of the invention, there is no particular requirement for any such limitation. For example, the application program can call upon computing resources and external to the personal media device 130, such as by accessing a server device coupled (using either a wired or wireless connection, or both) to the personal media device 130, or such as by accessing a cloud computing resource using a communication network.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. It should be understood that the exemplary procedures described herein can be stored on any computer accessible medium, including a hard drive, RAM, ROM, removable disks, CD-ROM, memory sticks, etc., and executed by a processing arrangement and/or computing arrangement which can be and/or include a hardware processors, microprocessor, mini, macro, mainframe, etc., including a plurality and/or combination thereof. In addition, certain terms used in the present disclosure, including the specification, drawings and numbered paragraphs thereof, can be used synonymously in certain instances, including, but not limited to, e.g., data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

1. An apparatus, comprising:
a headphone interface coupleable to a personal media device and disposed to receive one or more command signals and one or more output electronic audio signals from said personal media device;
said headphone interface including a command element disposed to distinguish said command signals from said electronic audio signals; and
said headphone interface disposed to operate one or more headphones in response to said command signals;
wherein said headphones perform additional functions in response to said headphone interface and said command signals.

2. An apparatus as in claim 1, wherein said command signals and said electronic audio signals are coupled to said one or more headphones, and said headphone interface is disposed to distinguish between a combination of said command signals and said electronic audio signals.

3. An apparatus as in claim 1, said personal media device including an element disposed to determine one or more command signals recognized by said headphone interface, and said personal media device including an element disposed to offer a user a choice of said functions for which command signals are recognized by said headphone interface.

4. An apparatus as in claim 1, wherein said one or more headphones each include one or more speakers locatable near a user's ear and one or more acoustic sensors locatable near said user's ear.

5. An apparatus as in claim 1, wherein said one or more headphones each include a switch disposed to disable or enable one or more acoustic sensors or speakers in response to said command signals.

6. An apparatus, comprising a headphone interface coupleable to a personal media device, said headphone interface including a command element disposed to receive and respond to command signals from said personal media device, wherein said headphone interface is disposed to couple a combined signal, including information from said command element and from one or more acoustic sensors, to said personal media device.

7. An apparatus as in claim 6, including:
a node coupling said personal media device to a decoder;
said decoder coupled to said command element;
said command element disposed to generate response signals in response to said command signals; and
an encoder coupled to said command signals and to said personal media device.

8. An apparatus as in claim 6, including acoustic sensors located at said headphones.

9. An apparatus as in claim 6, wherein said command element maintains state between command signals.

10. An apparatus as in claim 6, wherein said headphone interface is disposed to combine said input electronic audio signals before coupling said input electronic audio signals to said personal media device.

11. An apparatus as in claim 6, wherein said headphone interface is disposed to combine said input electronic audio signals before coupling said input electronic audio signals to said personal media device, and to de-combine said input electronic audio signals after receiving said input electronic audio signals at said personal media device.

12. An apparatus as in claim 6, wherein said headphone interface is disposed to receive one or more input electronic audio signals from said headphones, and to couple said input electronic audio signals to said personal media device.

13. An apparatus as in claim 6, wherein said personal media device is disposed to perform one or more instructions in response to said input electronic audio signals, wherein said command signals from said output electronic audio signals are responsive to said input electronic audio signals.

14. An apparatus as in claim 13, wherein said instructions analyze said input electronic audio signals, and said instructions apply signal processing to said output electronic audio signals.

15. An apparatus as in claim 13, wherein said instructions at said personal media device are alterable in response to a user command, and when said instructions are altered, said headphones can perform additional functions in response to said personal media device.
